(19) United States
(12) Patent Application Publication
(10) Pub. No.: US 2010/0121655 A1
(43) Pub. Date: May 13, 2010

(54) PATIENT DATA RECORD AND USER INTERFACE

(75) Inventors: Christian Lorenz, Eindhoven (DE); Hans Barschdorf, Eindhoven (NL); Jens Von Berg, Eindhoven (NL); Thomas Blaffert, Eindhoven (NL); Sebastian P. M. Dries, Eindhoven (NL); Sven Kabus, Eindhoven (NL)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/516,421

(22) PCT Filed: Nov. 22, 2007
(86) PCT No.: PCT/IB07/54740

§ 371 Date: Jan. 13, 2010

(30) Foreign Application Priority Data
Nov. 28, 2006 (EP) 06124958.7

(51) Int. Cl. G06Q 50/00; G06Q 10/00; G06F 17/30

(52) U.S. Cl. 705/3; 705/2; 707/722; 707/E17.141

(57) ABSTRACT

A patient data record is described comprising a mean model representative of the patient and further comprises at least one shape model to represent data concerning the patient, in which the said mean model comprises at least one region and the said shape model comprises at least one sub-section, and in which the at least one sub-section of the shape model is linked to the equivalent region of the mean model. This has the advantage of allowing greater structure to the patient record. Further a system is described to present patient data upon queries generated by a user and arranged to access the claimed patient data record, and which is further arranged to provide access to information in the sub-section of the shape model when a query generated by the user accesses the equivalent region of the mean model. This system allows full use of the improved patient data record.

### FIELD OF THE INVENTION

The invention relates to a patient data record to contain data concerning a patient.

Patient data records are known and are part of the common general knowledge in the field of hospital administration systems.

Further, shape models are known from the field of segmentation. A shape model can be described as a data structure which represents a true anatomical shape in the body of a patient. It is a mathematical model which can be made to encode the physical, geometrical shape of an anatomical object, or a collection of anatomical objects.

### BACKGROUND OF THE INVENTION

A specific embodiment of a shape model is described in ‘A Comprehensive Shape Model of the Heart’ by Cristian Lorenz and Jens von Berg, Medical Image Analysis 10 (2006); 657-670, available online at www.sciencedirect.com since 18 May 2006. This document discloses the setting up of a shape model from mean, i.e. average, patient data to produce a model based on a list of nodes and vertices in a model coordinate system which describe the shape of an average human heart. The nodes and vertices define a collection of connected triangles which form a virtual mesh taking the shape, in virtual space, of the mean heart. The model can be linked to a patient image data set representing or including the real heart of the patient and the model can be caused to adapt to the real heart in the data set using a method of alignment based on the maximization of two terms.

The mesh as disclosed above is constructed from triangles, but it is found that other geometrical shapes can be used to form a geometrical mesh.

Alternatively, shape models may be constructed from any other mathematical means which allow description of the geometrical shape of an anatomical objects or objects and examples include models based on geometrical functions and models based on series expansions. Regardless of the mathematical manner in which the model is set up, it can be used to describe anatomical objects such as the heart, the brain, the liver, the internal structure of the heart including the heart chambers, and also collections of such objects.

It is found that the shape model, when linked to a patient data set containing an example of the anatomical object which is the subject of the model and subsequently adapted, aligns itself to the shape of the real object as represented in the data set and thereby forms an acceptable segmentation of the real anatomical object.

Currently patient records are stored in the form of paper copies with associated X-ray films and other print-outs, for example ECG waveform paper printouts. These records take up considerable space and result in large hospital warehousing costs. Advances in computerization and in the storage of electronic data has allowed the development of computerized patient records. However, as medical advances allow for greater amounts of more complex data to be acquired while computing advances allow for the storage of greater amounts of data, it is unclear how best to arrange a patient data record to allow for optimal storage and retrieval of data.

### SUMMARY OF THE INVENTION

It is an object of the invention to produce a patient data record in which the data is stored in a structured way.

This is achieved according to the invention in which the patient data record also comprises a mean model representative of the patient and further comprises at least one shape model to represent data concerning the patient, in which the said mean model comprises at least one region and the said shape model comprises at least one sub-section, and in which the at least one sub-section of the shape model is linked to the equivalent region of the mean model.

A shape model, in being representative of the shape of an anatomical object, also contains a representation of the constituent structures within that anatomical object. For example, the heart model as disclosed above is essentially a list of points describing the shape of the heart and including the surfaces of the internal chambers of the heart, includes a reference to the topology of the coronary arteries and reference points within the overall structure including for example, but not necessarily exclusively, points representing the center of each heart chamber, the center of each valve and other suitable reference points. The model therefore also comprises sub-sections, for example in this case the chambers of the heart and the coronary arteries. Extending the analogy, an overall mean model can be constructed of a patient which can in principle also include various regions representative of the various anatomical sections and sub-sections of a possible patient anatomy. The overall mean model is in effect a data structure representing a template of a typical patient.

The shape model, by comprising sub-sections relating to a typical patient anatomy, can be used to provide a structure to the patient record which describes the individual who is the subject of the patient record. By linking the sub-sections of a shape mode included in the patient record with the equivalent regions of the mean model attached to the individual patient record it is found that the data in the patient record and which is included in the shape model is organized in a structured way and data is more readily and conveniently accessible.

The mean model representative of the patient is a queriable data structure which allows access to the information in the various linked shape models and any other data structures which can be added into the patient model.

In a preferred embodiment, the shape model is an adapted shape model. This means that the shape model is a shape model which has been adapted to a data set representing substantially the same anatomy that is represented by the shape model, as is known in the art from the disclosure above. This embodiment provides the advantage that information directly describing the anatomy of the patient is included, via the means of an adapted shape model, into the patient record. The link with the regions of the mean shape model allow this adapted information to be easily and efficiently accessed.

In another preferred embodiment, the shape model further comprises data of origin external to the shape model. It is known from the disclosure that shape models contain information describing the shape of an object, and depending on whether the model is a mean shape model or an adapted shape model, the shape will either represent a mean shape for an organ or other anatomical object, representative of the average shape for the anatomy in questions, or will represent the specific shape of the anatomy of the patient in question. In either case, it is also possible to attach extra data to the shape model. This data is not data originating from the shape model but can be, for example, data generated from other diagnostic methods and procedures.

In particular, the data of origin external to the shape model can be data originating from an ECG or an EEG measurement session. In this case an electronic version of an ECG recording can be attached to the shape model in the patient record which describes the heart. This shape model may or may not already be adapted to an image data set.

In the case of the shape model embodiment disclosed in the prior art, the data can be added to the shape model as further quanta of data attached to the existing shape model data points in the sub-section of the shape model to which the added data pertains, and this can be achieved by one skilled in the art using known techniques of computing. As an example, ECG data can be affixed as extra quanta attached to data points in the model which relate to the location of the ECG signal, in other words to locations in a heart shape model related to the production of the electrocardio signal.

As an example of further data which can be added to the shape models, derived data such as uptake values derived from other diagnostic procedures can be added to the sub-sections of the shape models to which they pertain.

In addition, the data can be added directly to the mean model representative of the patient and this is advantageous for example in the case of data which is not easily localizable to any particular anatomical shape model. An example of this might be information referring to drugs applied to the patient which have a systemic effect.

Although the mean model representative of the is a queriable data structure, it can also be a shape model itself. In this particular embodiment the linking of the at least one sub-section of the shape model to the equivalent region of the mean model is preferably achieved by performing a registration of the respective sections. This is performed using known techniques of registration and the resulting transformation which allows the data in one of either the sub-section or the region to be transformed into the other would normally also be stored in the patient record along with the mean model and the shape model or models. Once the transformation is known, the data points in the coordinate system of the shape models can be linked to an identifiable position in the mean model representative of the patient.

However, the linking can be achieved by other means known in the art of data access, in particular for example, when the mean model representative of the patient is not itself also a shape model, it can be achieved by the simple addressing of the sub-sections of the shape models from a list of reference points held in the mean model representative of the patient.

In addition, a shape model, in being representative of the shape of an anatomical object, also contains a representation of the constituent structures within that anatomical object and as such contains information relating to size, structure, relation in space etc. By analogy, an adapted model contains information pertaining to the specific structure of the relevant organ within an individual patient. The adapted shape model therefore serves as a useful source of information for the patient record and also serves as a useful store of information for data analysis on the patient. The information contained in the adapted shape models can be accessed by a suitably arranged data analysis program to allow comparison of information in the shape models. As an example, change in left ventricular volume over a period in time can be calculated by comparing left ventricular volume from two adapted shape models, both adapted to the patient heart.

The invention therefore also relates to a computer program product for the comparison of quantitative patient data and arranged to access quantitative patient data contained in a patient data record, characterized in that the quantitative patient data is in the form of an adapted shape model.

The invention also relates to a system to present patient data upon queries generated by a user and arranged to access a patient data record such as the one described above.

This system is arranged to provide access to information in the sub-section of the shape model when a query generated by the user accesses the equivalent region of the mean model.

Such a system has the advantage that it allows access to the data in the patient data record of the invention in an easy and efficient manner.

By linking the data in the sub-sections of the shape model to the regions of the mean model representative of the patient it is found that the data in the shape model can be accessed via the relevant region of the mean model. It is not necessary for the entire data in the shape model to be accessed. For example, a shape model might represent the heart, with sub-sections including the left ventricle. Data attached to the left ventricle can be accessed and pulled out of the patient record using a query to the region of the mean model concerning the left ventricle. The system and patient data record together therefore allow patient data to be stored in a manner that allows selective access to the individual data points.

The manner in which the data is queried and data accessed can be performed using known techniques of data extraction once the link between the data has been set up within the patient record.

A patient record according to the described invention has several advantages. During diagnosis and treatment of a patient and even more during the life-time of a patient, large amounts of medical data are acquired. In particular, the development of imaging technology and the development of greater computing power has ensured that imaging data sets have increased in size. Typically, each new data-set is assessed anew from the beginning, using a mean model and without the use of information derived from the history of the patient. Any data integration or comparison of new data with previous patient data has to take place in the conscious mind of the clinician. As a result, the principally available knowledge of the patient anatomy, function and physiology from previous examinations and image processing steps is not used in any structured way as a prior knowledge for the computer assisted assessment of newly generated data, and in particular for newly generated image data.

Furthermore, patient information pertaining to different anatomical regions, from different modalities and from different points in time are only accumulated in the patient record in a similar fashion to their accumulation on consecutive sheets of a hard copy patient record dossier. The information contained within is not assembled or linked in any structured way. The result of this is that prior to the use of this invention, the review of a patient clinical history required sequential examination of the accumulated data in order to select and review items of interest. The use of a patient shape models embedded into an individual patient record and linked to each other via a mean model representative of the patient and which accompanies the patient through the care cycle enables efficient quantification and change evaluation. A shape model is individualized to the first available medical image data and from then on can be adjusted to new image data by adaptation to the changes caused by disease or temporal changes. The link between the shape model and the mean model representative of the patient allows for structured storage and access of the acquired information. The result is a series of individualized patient models following the patient over time.

It is particularly advantageous if the new shape model incorporated into the patient record and derived from adaptation to a new data set according to the known method is itself an already pre-adapted shape model. Such a pre-adapted shape model is adapted from a data set representing substantially the same anatomy of the same patient. The shape model, as a mathematical construct to be applied to a data set, can be usefully applied to any data set representing or containing an example of the anatomical structure represented by the shape model and can be adapted to fit that object. However, in the same way that the mean shape model as initially applied to each data set is simply a mathematical representation of an average form of the anatomical object, the resultant adapted model is also merely a mathematical representation of the object, this time the object as represented in the data set to which the mean model has already been applied. The mathematical representation of the adapted model is in the same mathematical form as the mathematical representation of the mean model and can therefore also be applied to the contents of a data set. In the case of the embodiment described in the cited prior art, the mathematical model is in the form of a list of points describing a series of nodes and vertices which together make up the triangles of the model mesh. Although it would be expected that the mean model for an anatomical object, as representative of an average human anatomy of that object, would provide the best and most consistent segmentation result when applied to a data set comprising an example of that object, surprisingly, it is found that when the shape model is already adapted to data representing substantially the same anatomy of the patient, an improved and more accurately segmented shape model results from the adaptation process. The known model, as described in the prior art, is a mean shape model and as such describes the average geometrical shape of the anatomy which constitutes the subject of the shape model. The adaptation of the mean model to data representing the patient introduces a congruency into the model which when applied to a data set for adaptation produces a better and more consistent segmentation.

Use of a pre-adapted shape model requires much less effort and is less error prone as compared to an adaptation of a mean patient model. This results in reduced computational effort and reduced computation time as well as increased accuracy.

Automated quantitative measurements are enabled with the series of adapted models. The time series of individualized models can be used to define border conditions for advanced analysis, such as physiological simulations or disease modeling. Furthermore, the mean model representative of the patient now serves as a structured data accumulator. Combined with a suitable user interface the model can be queried for specific anatomical regions or organ systems to give an overview of the respective accumulated data. A “zoom-in” functionality can provide hierarchical access of specific patient data or associated data analysis.

It can be seen that use of the invention allows use of a patient model which accompanies the patient through the care cycle or even throughout the life of the patient. Consequently, the patient record contains in addition to medical image data and other examination results a set of model states, reflecting the patient situations for the different image data sets. Furthermore the access system to the patient data, for example a PACS may contain a user interface for model based data access to allow virtual examinations of the patient and such history as is collected and structured in the patient model.

The mean patient shape models may be selected from a set of mean models which for example account for differences in sex or age. The shape models contain at least information about the expected anatomy or portions of the anatomy but may also contain additional functional information, for example motion characteristics, physiological data, for example perfusion characteristics etc., and semantic information. The patient model is adapted to the image material by means of the known model to image adaptation techniques. Each model can be adapted to each subsequent examination, leading to a train of adapted models, the previous models also being stored, and as each previous model is adapted to new data it leads to a new temporal instance of the patient model. The difference between the previous model and the new model will in general be smaller than the difference between a mean patient shape model and the adapted shape model leading to short computation times and a higher accuracy as compared to an adaptation from scratch.

The resulting series of anatomical models capture the imaged patient morphology in a computer readable form and enable directly quantitative measurements of positions, distances, areas, volumes and their changes over time. The re-use of a once defined modeling structure in the follow-up examinations helps to make subsequent diagnosis better comparable with each other. This allows easy quantitative monitoring of diagnostically important parameters.

1. A patient data record to contain data concerning a patient wherein it further comprises a mean model representative of the patient and further comprises at least one shape model to represent data concerning the patient, in which said mean model comprises at least one region and the said shape model comprises at least one sub-section, and in which the at least one sub-section of the shape model is linked to an equivalent region of the mean model.

2. A patient data record as claimed in claim 1 wherein the shape model is an adapted shape model.

3. A patient data record as claimed in claim 1 wherein the shape model further comprises data of origin external to the shape model.

4. A patient data record as claimed in claim 3 wherein the data of origin external to the shape model is data originating from an ECG or an EEG measurement session.

5. A patient data record as claimed in claim 1 wherein the linking of the at least one sub-section of the shape model to the equivalent region of the mean model is achieved by performing a registration of the respective sections.

6. A computer program product for the comparison of quantitative patient data and arranged to access quantitative patient data contained in a patient data record, wherein the quantitative patient data is in the form of an adapted shape model.

7. A system to present patient data upon queries generated by a user and arranged to access a patient data record according to claim 1, the system further arranged to provide access to information in the sub-section of the shape model when a query generated by the user accesses the equivalent region of the mean model.

8. A patient data record as claimed in claim 7 wherein the shape model is pre-adapted to a data set representing substantially the same anatomy of the same patient.

9. A patient data record as claimed in claim 7 wherein the shape model further comprises data of origin external to the shape model.

10. A patient data record as claimed in claim 9 wherein the data of origin external to the shape model is data originating from an ECG or an EEG measurement session.
